(19) United States
(12) Patent Application Publication
(10) Pub. No.: US 2014/0202081 A1
(43) Pub. Date: Jul. 24, 2014

(54) WOOD STORM WINDOW

(71) Applicant: Daniel Robert Nehm, Chicago, IL (US)

(72) Inventor: Daniel Robert Nehm, Chicago, IL (US)

(73) Assignee: Landmark Upgrades LLC, Chicago, IL (US)

(21) Appl. No.: 13/747,481

(22) Filed: Jan. 23, 2013

(51) Int. Cl. E06B 5/00; E06B 9/52

(52) U.S. Cl. CPC E06B 5/003; E06B 9/52
USPC 49/63

(57) ABSTRACT

A wood storm window includes: an upper panel including a fixed pane of glass fixed within the upper panel from the exterior side of the wood storm window; a lower panel including an insect screen secured within the lower panel from the interior side of the wood storm window; and a removeable storm sash that may be positioned at varying positions along the interior side of the wood storm window, wherein the removal of the storm sash provides access to repair or replace the insect screen without needing to remove the wood storm window from an installed position.

### BACKGROUND OF THE INVENTION

The present subject matter relates generally to an improved wood storm windows. More specifically, the present subject matter discloses a window system that may be installed to provide modern conveniences such as a vertically movable and removable sash and insect screen, while retaining a traditional wood storm window appearance from the exterior.

Storm windows, or “secondary glazing” as they are known in the trade are a second window system that fits onto the outside of a primary window. While modern construction has largely moved away from storm windows, the use of quality, properly fitted and installed storm windows can be a very cost-effective and sustainable path to energy efficiency.

Storm windows can accomplish several objectives. First, they seal drafts out and create an insulating pocket of dead air between the primary window and the storm window. Storm windows also protect the primary window from weathering. Further, with the recent development of low-e glass, storm windows can even further improve their thermal efficiency (e.g., reflect sunlight from the outside in the summer, reflect radiant heat inward in the winter, etc.). Combined with proper weather stripping of the primary sash, storm windows provide nearly the same performance as a modern, insulating glass window.

Another advantage of storm windows is that they can be repaired, typically with simple materials. Conversely, modern insulating glass units may also offer excellent energy performance, but their glass seals have a limited lifespan. When the seals fail on a modern window, the window fogs and the entire sash must be sent to the landfill. For example, low-quality vinyl windows may experience seal failure within five years and high-quality wood windows may last as long as fifty years. For comparison, primary/storm systems utilizing single pane, low-e glass can last indefinitely because of their ability to be repaired.

One drawback with traditional storm windows is that they are often intended to be rotated between seasons. A summer storm window may include a fixed position insect screen to enable the primary window to be opened without risk of insect ingress, whereas the winter storm may include a fixed position glass sash to further protect the primary window. Accordingly, during any given season, the unused storm windows must be stored. Further, the manual labor required to swap seasonal storm windows is not trivial. For example, in many cases, storm windows are installed from the exterior, which can be particularly difficult for windows located above ground level.

In addition to being a cost-effective and sustainable path to energy efficiency, storm windows may be the only appropriate aesthetic choice for use in vintage, landmark, or otherwise architecturally important buildings. The visual character of a quality wood storm window may be the most appropriate match for these types of buildings. However, the various limitations described above may prevent an owner from installing quality wood storm windows where they may otherwise be the appropriate aesthetic solution.

Accordingly, there is a need for a system that may be used to provide quality wood storm windows that incorporate modern conveniences, while maintaining the traditional look of a wood storm window, as described and claimed herein.

### BRIEF SUMMARY OF THE INVENTION

The present disclosure provides an improved wood storm window system that may be provided as either a retrofit or new installation that incorporates advantages of modern window systems while maintaining the traditional aesthetic of wood storm windows.

In one example, an improved wood storm window system includes: (a) a casing including a top rail, middle rail, bottom rail, and two vertical stiles; (b) an upper panel including a fixed pane of glass secured between the top rail, middle rail, and the two vertical stiles; (c) an insect screen provided between the middle rail, bottom rail and two vertical stiles; and (d) a storm sash that is repositionable along a pair of vertical tracks located along the interior of the casing.

A description of a representative example of the improved wood storm window system is provided below, but it is understood that the absolute and relative dimensions provided herein may be varied to accommodate particular applications, as will be recognized by those skilled in the art based on the teachings provided herein.

In this example, the two vertical stiles are approximately 2¼″ wide and 1⅛″ deep. The top rail is approximately 2¼″ wide and 1⅛″ deep. The middle rail is approximately 1½″ wide and 1⅛″ deep. And the bottom rail is approximately 4″ wide and 1⅛″ deep. The middle rail divides the casing into an upper panel and a lower panel.

The top rail of the casing includes a pair of retainer clip slots. The retainer clip slots are located approximately at the upper left and upper right corners of the top rail. Each retainer clip slot is approximately ¼″ wide, ¾″ deep, and 3½″ long. These retainer clip slots may mate with angled brackets installed in the top of the window frame, which may make the improved wood storm window installation easier to complete from the interior of the window opening. The top rail further includes a weatherstrip slot approximately ⅛″ wide by ¼″ deep. This weatherstrip slot actually runs the entire perimeter of the casing, including both stiles and the bottom rail.

In an alternative embodiment in which the weatherstrip slot is located on the interior face of the wood sash. For example, in instances in which the building into which the improved wood storm window is to be installed has a shallow casing that would provide little surface against which the perimeter weatherstripping could seal, the weatherstrip slot may be provided in the interior face of the wood sash to seal against the blind stop of the primary window. The location of the weatherstrip slot may be provided in either location depending on site-specific condition.

The fixed pane of glass in the upper panel is secured in place from the exterior side of the system. It abuts a shoulder that runs along the inner side of the top rail, middle rail, and the two stiles. In one example, the shoulder is approximate ¼″ wide and set back approximately ½″ from the exterior face of the upper panel. The fixed pane is held in place using glazing putty around the entire perimeter of the opening. The glazing may form the beveled edge common in traditionally styled wood storm windows.

The insect screen is installed into the lower panel from the interior. It is stapled into the frame from the interior side onto a shoulder that is approximately ¾″ wide and approximately ½″ deep. A wood screen stop is nailed into the shoulder to hold the screen in place. The wood screen stop may be painted to match the storm sash finish. The wood screen stop further includes a gasketing slot approximately ⅛″ wide by ¼″ deep for sealing against the storm sash. For example, nylon brush gasketing may be pressure fit into the gasketing slot. The exterior side of the lower panel includes a 30-degree by ½″ bevel along the entire perimeter of the screen opening, which approximates the aesthetic of the glazing putty that secures the fixed pane in the upper panel. Securing the insect screen from the interior makes repair and/or replacement easier after installation is complete.

The storm sash is located along the interior of the casing. An aluminum angle spans the width of the storm sash along the bottom rail, which holds the storm sash in place when in the closed position. The two vertical sides of the storm sash are located between a pair of vertical channels that run along the height of the casing adjacent to the upper and lower panels. In a preferred embodiment, the vertical channels are embodied in a pair of “Z-trim” aluminum extrusions that are approximately ⅜″ deep and secured to the casing stiles with wood screws. The storm sash is captured within the vertical channels by a pair of tilt keys at the top of the storm sash and by a pair of slide bolts at the bottom of the storm sash. Accordingly, the storm sash can be easily removed from the vertical channels when desired.

In one embodiment, self-tapping screws installed through the aluminum Z-trim provide stops for engaging the slide bolts and positioning the storm sash at various heights within the vertical channels. In another example, the vertical channels may include a number of notched ridges along their height, any of which can be used as a stop. For example, a punch pressed metal strip may be applied to the internal channel formed by the Z-trim to provide the notched ridges. In some examples, the shape of the punch presses allow the storm sash to be raised without manually retracting the slide bolts.

In one embodiment, the lower edge of the bottom rail is beveled at an angle of 10 degrees sloping upward from front to back.

In an example in which the improved storm window disclosed herein is embodied in a retrofit to an existing wood storm window, the existing storm window may be modified by removing the glass from the lower panel of the window, adding an insect screen in its place, and then installing a sliding panel system behind the screen. Such an embodiment may be otherwise identical to the original construction described above, except that in the retrofit embodiment, the exterior bevel adjacent to the insect screen would be formed with putty, rather than by wood routed to resemble a putty line.

In one example, a wood storm window includes: a wood storm/screen sash including a top rail, middle rail, bottom rail, and two vertical stiles, the wood storm/screen sash including an interior side and an exterior side; an upper panel including a fixed pane of glass secured between the top rail, middle rail, and the two vertical stiles; an insect screen provided between the middle rail, the bottom rail and the two vertical stiles, wherein the insect screen is secured to middle rail along a first shoulder at the interior side of the middle rail and secured to the bottom rail along a second shoulder at the interior side of the bottom rail; and a storm sash that is repositionable along a pair of tracks located along the interior sides of the two vertical stiles.

In some embodiments of the example described above, the insect screen is stapled into the first shoulder and the second shoulder and a wood screen stop is nailed into each of the first shoulder and the second shoulder to hold the insect screen in place. The wood screen stop may further include a gasketing slot into which a nylon brush gasketing is pressure fit. Further, the exterior side of the middle rail, the exterior side of the bottom rail, and the portions of the two vertical stiles located between the middle rail and the bottom rail may be beveled to simulate glazing putty. The wood storm window may further include an angle spanning the width of the storm sash along the interior side of the bottom rail.

The pair of tracks may be standard Z-shaped aluminum extrusions and the storm sash may be removably held in place between the pair of tracks by a pair of tilt keys are the top of the storm sash and a pair of slide bolts at the bottom of the storm sash.

The fixed pane of glass may be secured from the exterior side of the wood storm/screen sash against a shoulder in the top rail, middle rail, and the two stiles and may be held in place with glazing putty

Further, the top rail may include a pair of retainer clip slots.

In another example, a wood storm window having an interior side and an exterior side includes: an upper panel including a fixed pane of glass fixed within the upper panel from the exterior side of the wood storm window; a lower panel including an insect screen secured within the lower panel from the interior side of the wood storm window; and a removeable storm sash that may be positioned at varying positions along the interior side of the wood storm window, wherein the removal of the storm sash provides access to repair or replace the insect screen without needing to remove the wood storm window from an installed position.

The upper panel may be defined by a top rail, middle rail, and two vertical stiles and the lower panel may be defined by a middle rail, a bottom rail, and two vertical stiles. The insect screen may be secured to the lower panel along a first shoulder at the interior side of the lower panel and a wood screen stop may be secured onto the shoulder hold the insect screen in place.

The storm sash may be repositionable along a pair of tracks located along the interior sides of two vertical stiles that span the upper panel and the lower panel. In some embodiments, the pair of tracks are Z-shaped aluminum extrusions and the storm sash is removably held in place between the pair of tracks by a pair of tilt keys are the top of the storm sash and a pair of slide bolts at the bottom of the storm sash.

In some examples, the wood storm window includes an angle spanning the width of the storm sash along the interior side of the lower panel and the top panel includes a pair of retainer clip slots.

An advantage of the systems provided herein is that it may be retrofit into existing window systems to help preserve or to help create the traditional, historic, landmark, and/or aesthetic character of the building.

Another advantage of the systems provided herein is that modern conveniences such as movable position sashes and insect screens may be provided within traditionally styled wood storm windows.

A further advantage of the systems provided herein is that retrofitting existing wood storm windows, rather than manufacturing them from scratch, may provide considerable cost savings, as the windows will have already been fit to the building, which will additionally save on field carpentry work as well.

Yet another advantage of the systems provided herein is that the lower moving glass pane sash may be easily removed from the installed window. This makes cleaning of glass and repairing of storm sash glass easier and reduces the weight of the assembly to allow easier installation of the unit into the primary window opening when the lower moving glass pane sash has been removed.

Another advantage of the systems provided herein is the weather-stripping is press fit into the wood components, making it easy to remove the weatherstripping for painting, or to replace the weatherstripping as needed.

Still another advantage of the systems provided herein is that the sliding sash may be positioned in any of a large number of stop positions along the height of the sliding track.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is an exterior view of the improved wood storm window.

FIG. 2 is an interior view of the improved wood storm window of FIG. 1.

FIG. 3a is a cross-sectional view through the upper panel of the improved wood storm window of FIG. 1.

FIG. 3b is a cross-sectional view through an alternative version of the upper panel of the improved window shown in FIG. 1.

FIG. 4 is a cross-sectional view through the lower panel of the improved wood storm window of FIG. 1.

FIG. 5 is a cross-sectional view through the full height of the improved wood storm window of FIG. 1.

FIGS. 6a-6c illustrate an alternative embodiment of the stops provided in the improved wood storm window of FIG. 1.

### DETAILED DESCRIPTION OF THE INVENTION

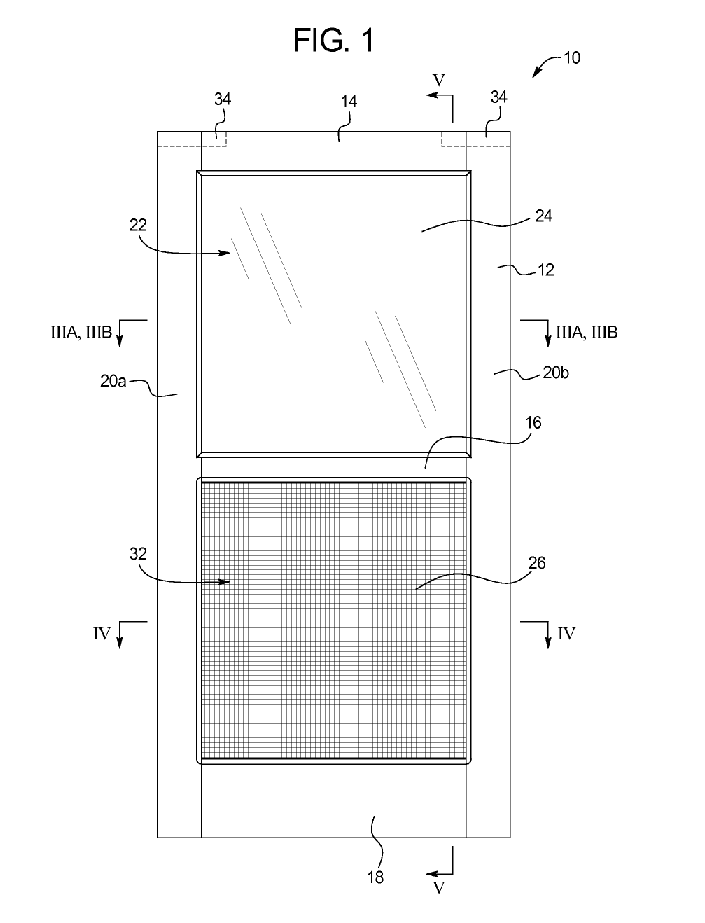

FIGS. 1-6 illustrate various views of an example of an improved wood storm window 10 as provided herein. The example shown in FIG. 1 is merely one example of an improved wood storm window 10 and those skilled in the art will recognize the numerous variations of embodiments that may be implemented based on the teachings disclosed herein.

In the example shown in FIGS. 1-6, an improved wood storm window 10 includes: (a) a wood storm/screen sash 12 (wood sash 12) including a top rail 14, middle rail 16, bottom rail 18, and two vertical stiles 20a and 20b; (b) an upper panel 22 including a fixed pane of glass 24 secured between the top rail 14, middle rail 16, and the two vertical stiles 20a and 20b; (c) an insect screen 26 provided between the middle rail 16, bottom rail 18 and two vertical stiles 20a and 20b; and (d) a storm sash 28 that is repositionable along a pair of vertical tracks 30 located along the interior of the wood sash 12.

While the example of the improved wood storm window 10 shown in FIGS. 1-6 is described herein including detailed dimensions of certain elements, the dimensions provided are illustrative and are used to teach those skilled in the art a single embodiment that is merely representative of the numerous embodiments that may be implemented based on the teachings provided herein. It is understood that both the absolute and the relative dimensions provided herein may be varied to accommodate particular applications, as will be recognized by those skilled in the art based on the teachings provided herein.

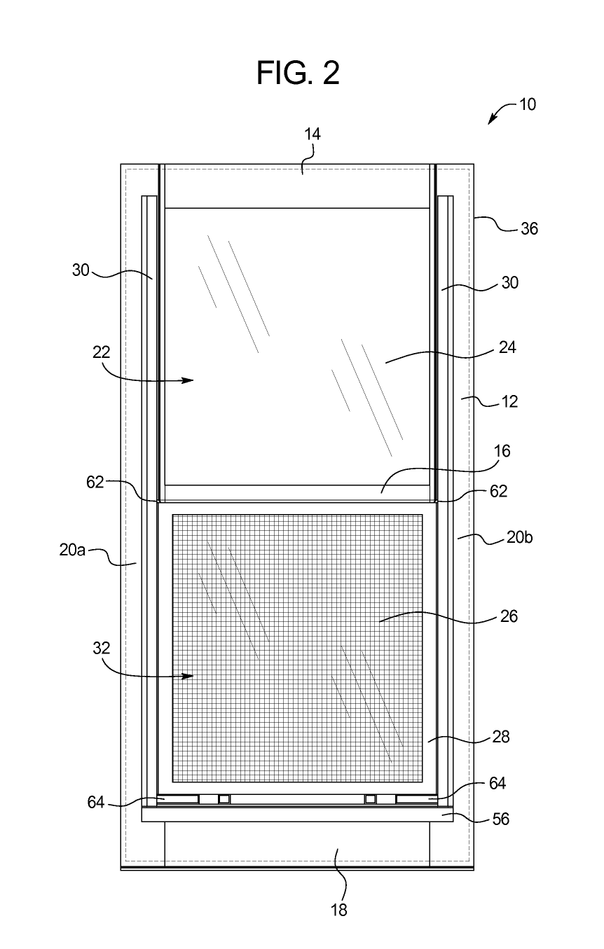

As shown in FIG. 2, in this example of an improved wood storm window 10, the two vertical stiles 20a and 20b are approximately 2¼″ wide and 1⅛″ deep. The top rail 14 is approximately 2¼″ wide and 1⅛″ deep. The middle rail 16 is approximately 1½″ wide and 1⅛″ deep. And the bottom rail 20 is approximately 4″ wide and 1⅛″ deep. The middle rail 18 divides the wood sash 12 into an upper panel 22 and a lower panel 32.

As further shown in FIG. 2, the top rail 14 of the casing includes a pair of retainer clip slots 34. The retainer clip slots 34 are located approximately at the upper left and upper right corners of the top rail 14. Each retainer clip slot 34 is approximately ¼″ wide, ¾″ deep, and 3½″ long. These retainer clip slots 34 may mate with angled brackets (not shown) installed in the top of the window frame (not shown), which may make the improved wood storm window 10 installation easier to complete from the interior of the window opening. The top rail 14 further includes a weatherstrip slot 36 that is approximately ⅛″ wide by ¼″ deep. This weatherstrip slot 36 actually runs the entire perimeter of the wood sash 12, including both stiles 20a and 20b and the bottom rail 18.

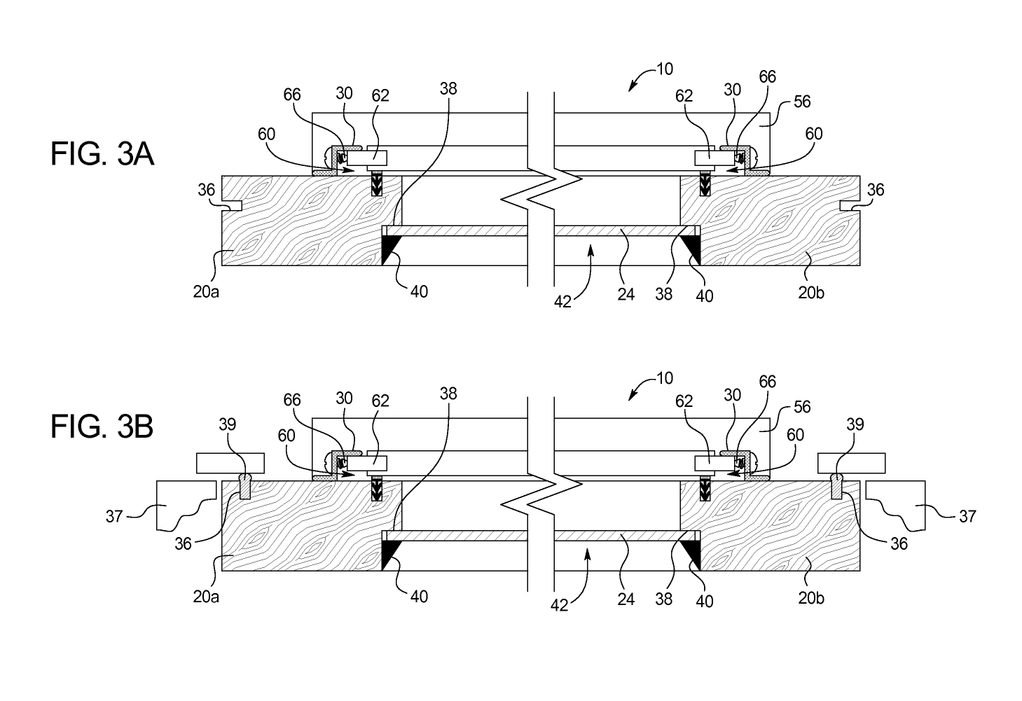

FIG. 3a illustrates a cross-sectional view of the embodiment of the improved wood storm window 10 described above. FIG. 3b illustrates an alternative embodiment in which the weatherstrip slot 36 is located on the interior face of the wood sash 12. For example, in instances in which the building into which the improved wood storm window 10 is to be installed has a shallow casing 37 that would provide little surface against which the perimeter weatherstripping 39 could seal, the weatherstrip slot 36 may be provided in the interior face of the wood sash 12 to seal against the blind stop of the primary window. The location of the weatherstrip slot 36 may be provided in either location depending on site-specific condition, as will be recognized by those skilled in the art based on the disclosure provided herein.

In alternative embodiments, the improved storm window 10 may not include the retainer clip slots 34 or may include other elements adapted to assist in the placement and securing of the improved storm window 10.

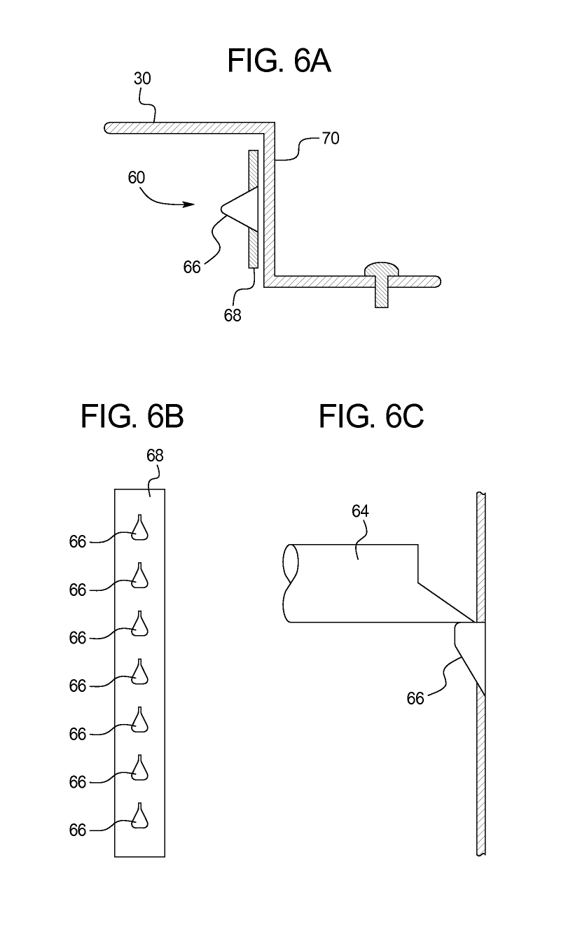

The fixed pane of glass 24 in the upper panel 22 is secured in place from the exterior side of the improved storm window 10. It abuts a shoulder 38 (FIG. 6) that runs along the inner side of the top rail 14, middle rail 16, and the two stiles 20a and 20b. In one example, the shoulder 38 is approximate ¼″ wide and set back approximately ½″ from the exterior face of the upper panel 22. The fixed pane 24 is held in place using glazing putty 40 around the entire perimeter of the opening 42 in the upper panel 22. The glazing putty 40 may form a beveled edge common in traditionally styled wood storm windows.

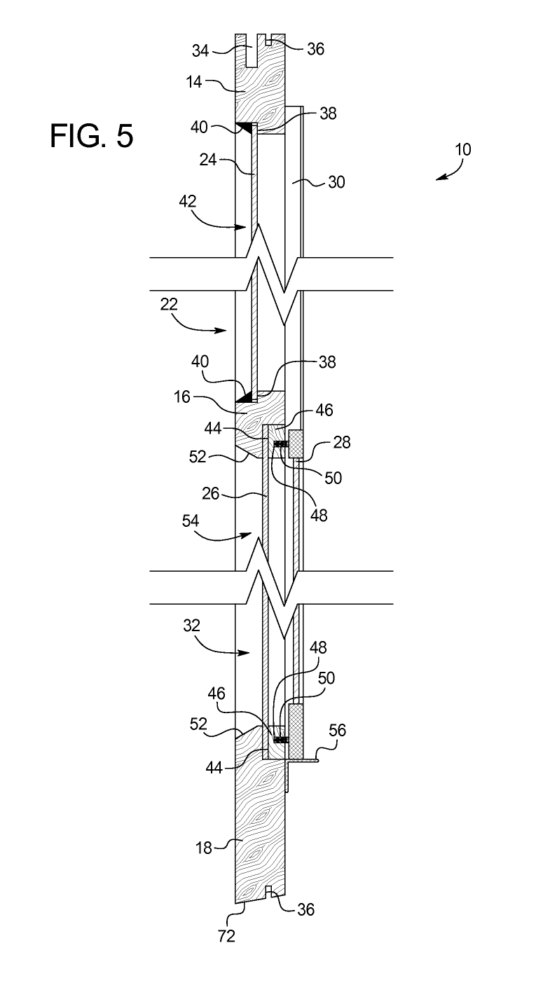

The insect screen 26 is installed into the lower panel 32 from the interior. The insect screen 26 is stapled into the wood sash 12 from the interior side onto a shoulder 44 (FIG. 5) that is approximately ¾″ wide and approximately ½″ deep. A wood screen stop 46 is nailed into the shoulder 44 to hold the insect screen 26 in place. The wood screen stop 46 may be painted to match the finish of the storm sash 28. The wood screen stop 46 further includes a gasketing slot 48 approximately ⅛″ wide by ¼″ deep for sealing against the storm sash 28. For example, nylon brush gasketing 50 may be pressure fit into the gasketing slot 48. As shown in FIG. 5, the exterior side of the lower panel 32 includes a 30-degree by ½″ bevel 52 along the entire perimeter of the screen opening 54, which approximates the aesthetic of the glazing putty 40 that secures the fixed pane 24 in the upper panel 22. Securing the insect screen 26 from the interior makes repair and/or replacement easier after installation is complete.

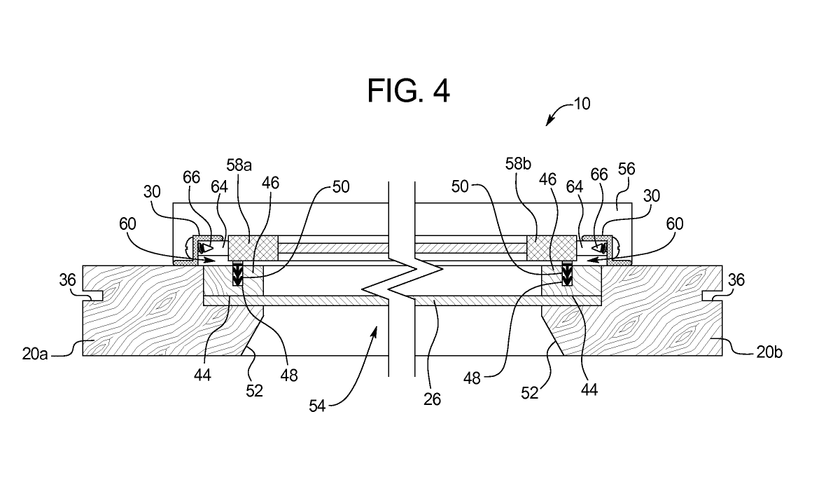

The storm sash 28 is located along the interior of the wood sash 12. An aluminum angle 56 spans the width of the storm sash 28 along the bottom rail 18, which holds the storm sash 28 in place when in the closed position. As shown in FIG. 4, the two vertical sides 58a and 58b of the storm sash 28 are located between a pair of vertical channels 60 that run along the height of the wood sash 12 adjacent to the upper panel 22 and the lower panel 32. In a preferred embodiment, the vertical channels 60 are embodied in a pair of “Z-trim” aluminum extrusions that are approximately ⅜″ deep and secured to the stiles 20a and 20b with wood screws (not shown). The storm sash 28 is captured within the vertical channels 60 by a pair of tilt keys 62 at the top of the storm sash 28 and by a pair of slide bolts 64 at the bottom of the storm sash 28. Accordingly, the storm sash 28 can be easily removed from the vertical channels 60 when desired.

In one embodiment, self-tapping screws installed through the aluminum Z-trim provide stops 66 for engaging the slide bolts 64 and positioning the storm sash 28 at various heights within the vertical channels 60. In another example, the vertical channels 60 may include a number of notched ridges along their height (as shown in FIGS. 7a and 7b), any of which can be used as a stop 66. For example, a punch pressed metal strip 68 may be applied to the internal channel formed by the Z-trim 70 to provide the notched ridges that comprise the stops 66. The configuration of the stops 66 may enable the storm sash 28 to be raised without a need for manual manipulation of the slide bolts 64.

In one embodiment, the lower edge 72 of the bottom rail 18 is beveled at an angle of 10 degrees sloping upward from exterior to interior.

In an example in which the improved storm window 10 disclosed herein is embodied in a retrofit to an existing wood storm window, the existing storm window may be modified by removing the glass from the lower panel of the window, adding an insect screen 26 in its place, and then installing a sliding panel system behind the screen. Such an embodiment may be otherwise identical to the original construction described above, except that in the retrofit embodiment, the exterior bevel 52 adjacent to the insect screen 26 would be formed with putty, rather than by wood routed to resemble a putty line.

The examples provided above are illustrative of a number of features and structural elements that may be incorporated into an improved storm window 10. It should be noted that various changes and modifications to the presently preferred embodiments described herein will be apparent to those skilled in the art. Such changes and modifications may be made without departing from the spirit and scope of the present invention and without diminishing its attendant advantages. For example, various embodiments of an improved storm window 10 may be provided based on various combinations of the features and functions from the subject matter provided herein.

I claim:

1. A wood storm window comprising:
a wood storm/screen sash including a top rail, middle rail, bottom rail, and two vertical stiles, the wood storm/screen sash including an interior side and an exterior side;
an upper panel including a fixed pane of glass secured between the top rail, middle rail, and the two vertical stiles;
an insect screen provided between the middle rail, the bottom rail and the two vertical stiles, wherein the insect screen is secured to middle rail along a first shoulder at the interior side of the middle rail and secured to the bottom rail along a second shoulder at the interior side of the bottom rail; and
a storm sash that is repositionable along a pair of tracks located along the interior sides of the two vertical stiles.

2. The wood storm window of claim 1 wherein the insect screen is stapled into the first shoulder and the second shoulder and a wood screen stop is nailed into each of the first shoulder and the second shoulder to hold the insect screen in place.

3. The wood storm window of claim 2 wherein the wood screen stop further includes a gasketing slot into which a nylon brush gasketing is pressure fit.

4. The wood storm window of claim 2 wherein the exterior side of the middle rail, the exterior side of the bottom rail, and the portions of the two vertical stiles located between the middle rail and the bottom rail are beveled to simulate glazing putty.

5. The wood storm window of claim 1 further including an angle spanning the width of the storm sash along the interior side of the bottom rail.

6. The wood storm window of claim 1 wherein the pair of tracks are Z-shaped aluminum extrusions.

7. The wood storm window of claim 6 wherein the storm sash is removably held in place between the pair of tracks by a pair of tilt keys are the top of the storm sash and a pair of slide bolts at the bottom of the storm sash.

8. The wood storm window of claim 1 wherein the fixed pane of glass is secured from the exterior side of the wood storm/screen sash against a shoulder in the top rail, middle rail, and the two stiles.

9. The wood storm window of claim 8 wherein the fixed pane is held in place with glazing putty.

10. The wood storm window of claim 1 wherein the top rail includes a pair of retainer clip slots.

11. A wood storm window having an interior side and an exterior side comprising:
an upper panel including a fixed pane of glass fixed within the upper panel from the exterior side of the wood storm window;
a lower panel including an insect screen secured within the lower panel from the interior side of the wood storm window; and
a removeable storm sash that may be positioned at varying positions along the interior side of the wood storm window, wherein the removal of the storm sash provides access to repair or replace the insect screen without needing to remove the wood storm window from an installed position.

12. The wood storm window of claim 11 wherein the upper panel is defined by a top rail, middle rail, and two vertical stiles.

13. The wood storm window of claim 11 wherein the lower panel is defined by a middle rail, a bottom rail, and two vertical stiles.

14. The wood storm window of claim 11 wherein the insect screen is secured to the lower panel along a first shoulder at the interior side of the lower panel.

15. The wood storm window of claim 14 wherein a wood screen stop is secured onto the shoulder hold the insect screen in place.

16. The wood storm window of claim 11 wherein the storm sash is repositionable along a pair of tracks located along the interior sides of two vertical stiles that span the upper panel and the lower panel.

17. The wood storm window of claim 16 wherein the pair of tracks are Z-shaped aluminum extrusions.

18. The wood storm window of claim 17 wherein the storm sash is removably held in place between the pair of tracks by a pair of tilt keys are the top of the storm sash and a pair of slide bolts at the bottom of the storm sash.

19. The wood storm window of claim 18 further including an angle spanning the width of the storm sash along the interior side of the lower panel.

20. The wood storm window of claim 11 wherein the top panel includes a pair of retainer clip slots.
